(19) United States
(12) Patent Application Publication
(10) Pub. No.: US 2025/0236177 A1
(43) Pub. Date: Jul. 24, 2025

(54) Method for Integrating an Electrically Activatable Display Element in an Outer Skin of a Vehicle Body, and Motor Vehicle

(71) Applicant: Bayerische Motoren Werke Aktiengesellschaft, Muenchen (DE)

(72) Inventors: Nicolas BEHRENS, Marzling (DE); Markus DIX, Kueps (DE)

(21) Appl. No.: 18/699,395

(22) PCT Filed: Oct. 24, 2023
(86) PCT No.: PCT/EP2023/079532

§ 371 Date: Apr. 8, 2024

(30) Foreign Application Priority Data
Dec. 1, 2022 (DE) 10 2022 131 825.7

(51) Int. Cl. B60K 35/50; B60K 35/22; B60K 35/60

(52) U.S. Cl. CPC B60K 35/50; B60K 35/22; B60K 35/60; B60K 2360/797; B60K 2360/816; B60K 2360/92

(57) ABSTRACT

A method integrates an electrically activatable display element in a body outer skin of a motor vehicle body or a motor vehicle body element. The method: a) provides a body structure comprising the body outer skin, the body outer skin having an outer surface facing the vehicle outer side and an inner surface facing the vehicle inner side; b) introduces at least one viewing window aperture into the body outer skin; c) deposits at least one adhesive web on the inner surface of the body outer skin in the region of the edges of the at least one viewing window aperture; d) applies the display element to the adhesive web; e) applies a potting compound, from the vehicle inner side, to the display element and to that region of the inner surface of the body outer skin that surrounds the display element, in order to seal the display element with respect to the surrounding area on the vehicle inner side; f) applies a transparent film, from the body outer side, to the outer surface of the body outer skin at least in the region of the at least one aperture, so as to sealingly surround the edges of the aperture or f′) pots the at least one body aperture with a transparent potting compound, in order to sealingly close the body aperture and f″) sands and polishes the hardened transparent potting compound; g) connects the display element to an electrical energy supply and control device.

### TECHNICAL FIELD

The invention relates to a method for integrating an electrically activatable display element in a body outer skin of a motor vehicle body or a motor vehicle body element. It also relates to a motor vehicle having an electrically activatable display element integrated in the body outer skin by such a method.

### BACKGROUND

It is known from theory and from concept vehicles to provide display devices having a variable optical appearance in or on the body outer skin of vehicles. Such displays or lighting elements are usually integrated behind or in transparent panes or components, or adhesively bonded behind them. However, it is not possible to provide a transparent component consisting of plastic anywhere on the vehicle, since the component sometimes does not meet the mechanical, electromagnetic or economic requirements for a vehicle body element.

DE 20 2005 020 199 U1 discloses a body element for a motor vehicle body, the body outer skin of which is provided with an aperture in which a transparent pane is inserted, behind which a backlit static mask is attached. In the aperture in the body outer skin, instead of the pane provided with the backlit mask, an LCD display can also be inserted in the aperture. Providing the aperture weakens the body outer skin in terms of its mechanical properties. An electromagnetic shielding formed by the metallic body outer skin is also interrupted by such an aperture.

DE 10 2019 131 997 A1 discloses a method for integrating a display in a body outer skin and a motor vehicle having such a body outer skin, the display being provided on the outer side of the body outer skin and inserted in a depression in the body outer skin. In this embodiment, the display is constantly exposed to weathering influences acting on the vehicle from the outside.

German patent application DE 10 2022 000 005.9, which is not a prior publication, describes an e-paper film for application to the body outer skin of a motor vehicle, the e-paper film being provided with a pattern of compression slots that locally sever the film, as a result of which the e-paper film becomes flexible and can match the body contour.

### SUMMARY

An object of the present invention is to provide an improved method for integrating an electrically activatable display element in a body outer skin. A corresponding motor vehicle is also to be provided.

A method according to the invention for integrating an electrically activatable display element in a body outer skin of a motor vehicle body or a motor vehicle body element comprises the following steps:
a) providing a body structure comprising the body outer skin, the body outer skin having an outer surface facing the vehicle outer side and an inner surface facing the vehicle inner side;
b) introducing at least one viewing window aperture into the body outer skin;
c) depositing at least one adhesive web on the inner surface of the body outer skin in the region of the edges of the at least one viewing window aperture;
d) applying the display element to the adhesive web;
e) applying a potting compound, from the vehicle inner side, to the display element and to that region of the inner surface of the body outer skin that surrounds the display element, in order to seal the display element with respect to the surrounding area on the vehicle inner side;
f) applying a transparent film, from the body outer side, to the outer surface of the body outer skin at least in the region of the at least one aperture, so as to sealingly surround the edges of the aperture
or
f′) potting the at least one viewing window aperture with a transparent potting compound, in order to sealingly close the viewing window aperture and
f″) sanding and polishing the hardened transparent potting compound;
g) connecting the display element to an electrical energy supply and control device.

In this respect, the motor vehicle body, or the motor vehicle body element, forms the body structure that has the body outer skin and is provided with the display element. A motor vehicle body element is understood to mean an independent component of the motor vehicle body, for example a fender, a bumper cladding, a vehicle door or a body flap.

By adhesively bonding the display element to the body outer skin, the body outer skin is stiffened in the region of the viewing window aperture and the display element is sealed and additionally stiffened by the potting compound applied to its rear side and possibly also by its transparent potting compound applied to the front side.

The display element is preferably formed by a display film, into which a pattern of compression slots, which pass through the display film in the thickness direction and confer flexible properties on the display element, is cut in a pretreatment step v) prior to application to the adhesive web in step d). This makes it possible to adapt the display element to a three-dimensionally curved shape of the body outer skin. In this case, it is particularly advantageous when the display film is an e-paper film.

It is moreover advantageous when the body outer skin is subjected to cathodic dip coating in a method step b′) prior to the application of the adhesive web in step c). In the case of a metallic body outer skin, in particular consisting of iron, this also provides corrosion protection with respect to the adhesive of the adhesive web.

It is also advantageous when the outer surface of the body outer skin is provided with a paint finish comprising at least one coat of paint in a method step c″) after the deposition of the adhesive web in step c) and before the application of the display unit in step d).

It is also advantageous when a covering which covers the display unit is applied and connected, preferably adhesively bonded, to the inner surface of the body outer skin in a further step e′) after the application of the potting compound in step e). Such a covering, which can consist, for example, of metal or another dimensionally stiff material, such as a fiber-reinforced plastic, contributes to stiffening the body outer skin owing to the connection, which preferably completely surrounds the viewing window aperture, to the body outer skin.

Preferably, the adhesive web deposited on the inner surface of the body outer skin in step c) surrounds the edge of the at least one viewing window aperture. This makes it possible to adhesively bond the display element around its entire periphery, as a result of which the adhesive web not only provides a seal between the edge of the viewing window aperture and the display element, but furthermore bonds the display element, in the form of a mechanical panel, to the body outer skin entirely in force-fitting fashion.

Preferably, the adhesive web deposited on the inner surface of the body outer skin in step c) forms a closed adhesive surface, to which the display element is connected over a large area in step d).

That part of the object that is directed to the motor vehicle is achieved by the features of patent claim 8 and, in an alternative, by the features of patent claim 9.

What is provided is a motor vehicle having an electrically activatable display element which is integrated in a body outer skin of a motor vehicle body or a motor vehicle body element and is produced by a method as set out above, having at least one viewing window aperture which is formed in the body outer skin and behind which the display element is provided on the inner side of the body outer skin, and having a transparent viewing window layer provided in or on the outer surface of the body outer skin in front of or in at least one viewing window aperture, and this motor vehicle is distinguished in that the at least one viewing window aperture is filled with the transparent potting compound and in that the transparent potting compound is polished on its outer side and the surface of which merges, preferably seamlessly, into the surrounding outer surface of the body outer skin.

An alternative embodiment of a motor vehicle having an electrically activatable display element which is integrated in a body outer skin of a motor vehicle body or a motor vehicle body element and is produced by a method as described above, having at least one viewing window aperture which is formed in the body outer skin and behind which the display element is provided on the inner side of the body outer skin, and having a transparent viewing window layer provided in or on the outer surface of the body outer skin in front of or in at least one viewing window aperture is provided, and this motor vehicle is distinguished in that the at least one viewing window aperture is covered by a transparent film connected to the body outer skin.

In both variants of the motor vehicle according to the invention, the external surface of the vehicle body is smooth, since the outer surface of the body outer skin and the surface of the viewing window region merge seamlessly into one another. This improves not only the visual appearance of the body, but also primarily the aerodynamic properties of the motor vehicle.

Preferred exemplary embodiments of the invention with additional embodiment details and further advantages are described and explained in more detail below with reference to the appended drawing.

### BRIEF DESCRIPTION OF THE DRAWINGS

FIG. 1 is an enlarged sectional illustration of a first embodiment of a display element designed according to the invention;

FIG. 2 is the sectional illustration of FIG. 1 in a second, alternative embodiment;

FIG. 3 is a plan view of a segmented e-paper film; and

FIG. 4 is a schematic illustration of a method designed according to the invention.

### DETAILED DESCRIPTION OF THE DRAWINGS

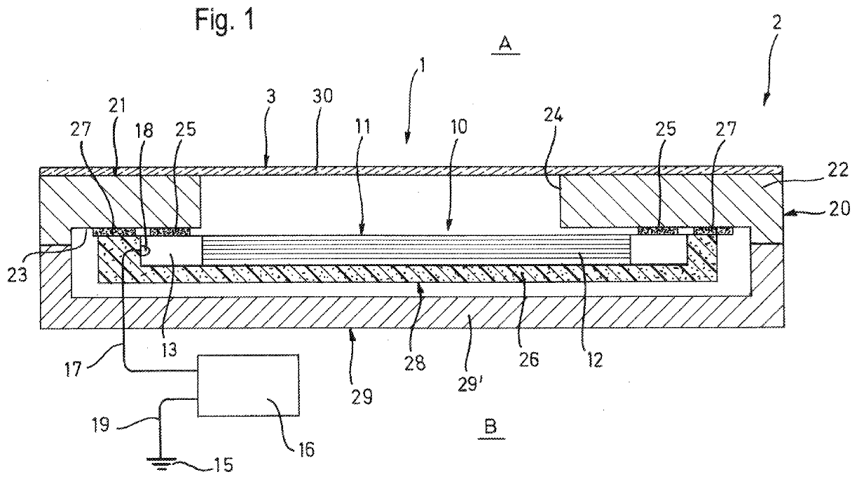

FIG. 1 shows a sectional illustration of a display element 10, formed by a first variant of the method according to the present invention, of a display unit 1. FIG. 1 shows a body structure, which is part of a motor vehicle body 20 of a motor vehicle 2. A viewing window aperture 24 is formed in the body outer skin 22 of the motor vehicle body 20. The body outer skin 22 has an outer surface 21 facing the vehicle outer side A and an inner surface 23 facing away from the outer side and directed toward the vehicle inner side B.

The display unit 1 is formed on that side of the body outer skin 22 that faces the vehicle inner side B by the method according to the invention, which will be described below. The display unit 1 has the display element 10 which is made, for example, of an e-paper film 11 and has an active display region 12 and a fastening edge 13. Instead of an e-paper film, it is also possible to provide any other type of electrically operated displays, for example LCD displays, OLED displays, or the like.

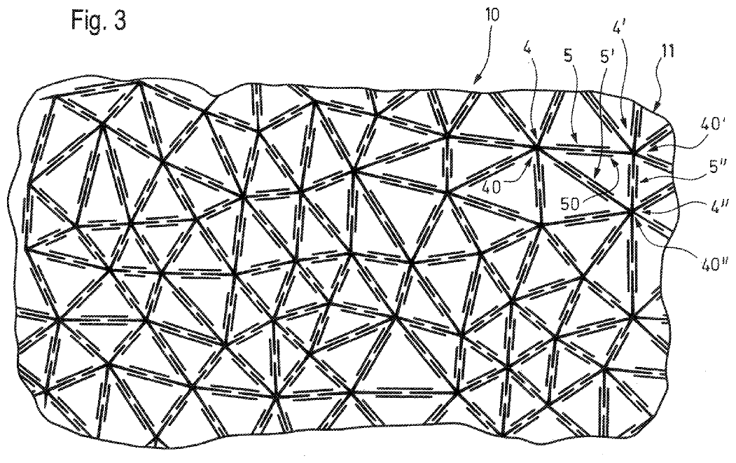

The e-paper film 11 may indeed be designed for attachment in a flat body region, but it may also have a two-dimensionally or three-dimensionally curved form in order to be able to match the spatial shape of the body outer skin 22. An e-paper film 11 suitable for this has a segmented form, as will be described below in connection with FIG. 3.

The display element 10, for example the e-paper film 11 shown here, is formed with a fastening edge 13, which is connected to the body outer skin 22 by means of at least one adhesive web 25 applied to the inner surface 23. The fastening edge 13 also has electrical connection contacts for the display element 10, for example electrical ground contacts, into which, for example, conductor tracks of the e-paper film 11 lead. These electrical ground contacts make electrically conductive contact, for example by way of spot soldering or spot welding, with the motor vehicle body 20 as an electrical ground 15 of the motor vehicle.

An electrical supply and control device 16, illustrated only schematically in the figures, for the display element 10 is electrically conductively connected via a first electrical supply line 17 to second connection contacts, for example positive pole contacts 18, formed in the fastening edge 13 of the display element 10. A second electrical supply line 19 leads from the electrical supply and control device 16 to the electrical ground 15 of the motor vehicle.

A potting compound 26, which surrounds the display element, that is in this case the e-paper film 11, on the back side and at the edges and is either connected there directly to the inner surface 23 of the body outer skin 22 or is sealingly adhesively bonded by means of an adhesive layer 27 surrounding the periphery of the viewing window aperture 24, is applied to the back side of the display element 10, which faces the vehicle inner side B. In this way, the potting compound 26 forms an internal covering 28, which liquid-tightly seals the display element 10, in this case formed by the e-paper film 11, with respect to the body outer skin 22.

A mechanically stiffer cover 29′ forms an external covering 29, covers the unit of the display element 10 and the internal covering 28 on the vehicle inner side B, and is mechanically fixedly connected to the body outer skin 22, spanning the viewing window aperture 24. As a result, the external cover 29 stiffens the body outer skin 22 in the region of the viewing window aperture 24.

A transparent film 30, which adheres fixedly, for example is adhesively bonded, to the body outer skin 22 is provided on the outer surface 21 of the body outer skin 22. The transparent film 30 spans the at least one viewing window aperture 24 and forms a transparent viewing window layer 3 there. The viewing window aperture 24, and thus also the space where the display element 10 is, is thus also sealed with respect to the surrounding area of the motor vehicle 2 on the outer side A against the ingress of moisture.

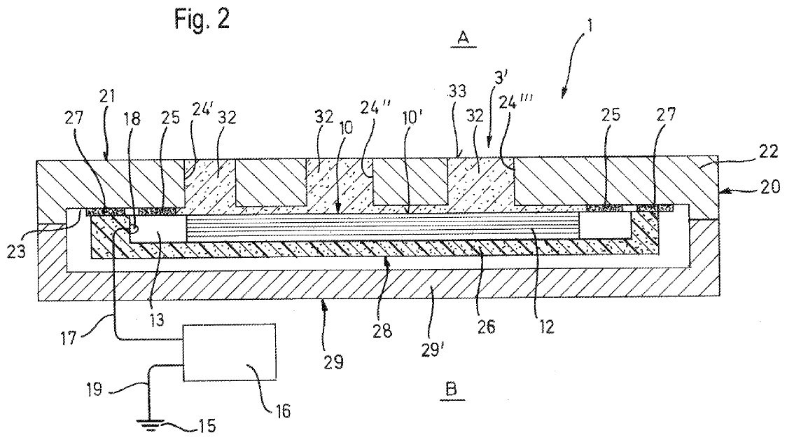

A second, modified embodiment of a display unit 1 integrated in the body outer skin 22 of a motor vehicle body 20 of a motor vehicle 2 by an alternative variant of the method according to the invention is illustrated in FIG. 2. Except for the design of the transparent viewing window layer 3′, this embodiment corresponds to that from FIG. 1. Therefore, only the differences will be described here. After the display unit 1 has been mounted, which is done like in the example of FIG. 1, on the body outer skin 22, the back side of the display unit 1 has been potted to form the internal covering 28 and the external cover 29 has been attached to the back side of the body outer skin 22, the at least one viewing window aperture 24′, 24″, 24′″ is filled with a transparent potting compound 32 to form the transparent viewing window layer 3′, the transparent potting compound also entering and filling the gaps formed between the front side 10′ of the display unit 1 and the inner surface 23 of the body outer skin 22. This transparent potting compound 32 is polished on its outer surface 33, which faces the vehicle outer side A, and adapted to the outer surface 21, surrounding the viewing window aperture 24, of the body outer skin 22, so that the two outer surfaces 21, 33 merge seamlessly and smoothly into one another.

FIG. 3 shows a detail of an area of a segmented e-paper film 11, described in the German patent application DE 10 2022 000 005.9, which is not a prior publication, the segmented e-paper film being provided with a multiplicity of compression regions 4, 4′, 4″ and expansion regions 5, 5′, 5″. Each compression region 4, 4′, 4″ has a star-shaped compression element 40, 40′, 40″, which is formed by a plurality of compression slots which diverge in a star shape from a common center and pass through the segmented e-paper film 11 in the thickness direction. An expansion element 50, which is provided with expansion slots and forms an expansion region 5, is always provided between two adjacent compression elements 40, 40′. The expansion slots also pass through the e-paper film 11 in the thickness direction.

If a tensile force which acts transversely, for example at right angles, to the longitudinal extent of an expansion slot is applied to this segmented e-paper film 11 in the film surface, the width of the expansion slot increases, as a result of which the decorative film 2 locally expands in this region transversely to the longitudinal extent. If a compressive force or shear force which acts toward the center of a compression element 40 is applied to the e-paper film 11 in the film surface, the width of at least one compression slot is reduced, as a result of which the e-paper film 11 is locally compressed in this region. These local expansion and compression capabilities of the segmented e-paper film 11 make it possible to three-dimensionally deform the e-paper film 11 and adapt it to body curvatures.

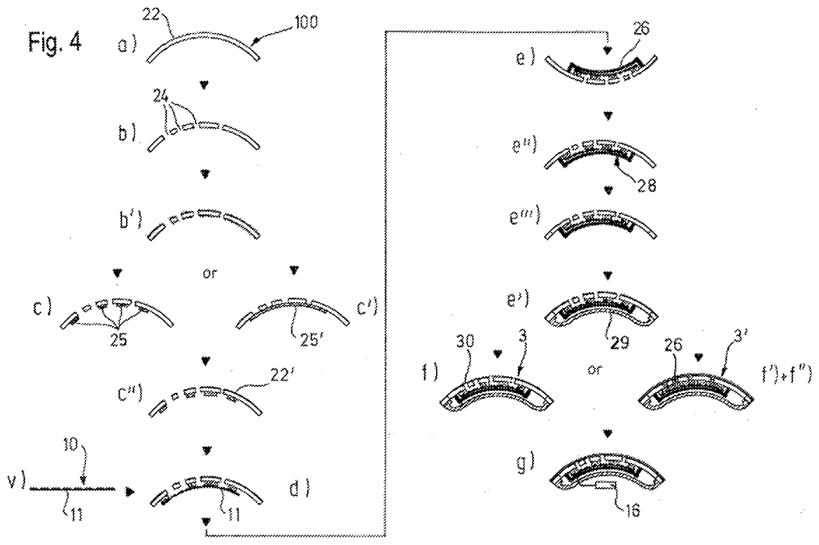

FIG. 4 illustrates the sequence of the method according to the invention for integrating an electrically activatable display unit 1 in a body outer skin 22 on the basis of a workflow diagram.

First of all, an already shaped body panel 100, which forms a body structure 20′ having the body outer skin 22, is provided in step a) for the method according to the invention. In a subsequent step b), at least one viewing window aperture 24 is introduced into the body outer skin 22, for example by lasering. This body outer skin 22 provided with viewing window apertures 24 is then optionally subjected to cathodic dip coating (CDC) in a step b′) and in so doing provided with an anticorrosion layer. Subsequently, in a step c), at least one adhesive web 25 is deposited on the inner surface 23 of the body outer skin 22 in the region of the edges of the at least one viewing window aperture 24. As an alternative, the adhesive may be deposited on a large area of the inner surface 23 of the body outer skin 22 in step c′, and it thus forms a large-area adhesive layer 25′. In an intermediate step c″), the outer surface 21 of the body outer skin 22 is provided with a paint finish having at least one coat of paint 22′.

In step d), the display element 10 formed in this case by an e-paper film 11 segmented in a pretreatment step v) is then either locally applied to the adhesive web(s) 25 or over a large area to the large-area adhesive layer 25′. After that—after the body element is turned over—in step e), a potting compound 26 is applied, from the vehicle inner side B, to the display element 10 and to that region of the inner surface 23 of the body outer skin 22 that surrounds the display element 10 to form an internal covering 28 of the display unit 1, in order to seal the display element 10 with respect to the surrounding area on the vehicle inner side B later on.

Subsequently, after preparing corresponding joins on the inner surface 23 of the body outer skin 22 in preparation steps e″) and e′″), an external covering 29, for example a mechanically stiffer cover 29′, covering the display unit 1 is applied and connected, preferably adhesively bonded, to the inner surface 23 of the body outer skin 22 in a further step e′). After that, a transparent viewing window layer 3, 3′ is attached in the region of the viewing window aperture 24. This is done either in step f) by applying a transparent film 30, from the body outer side, to the outer surface 21 of the body outer skin 22 at least in the region of the at least one viewing window aperture 24, sealingly surrounding the edges of the viewing window aperture 24, or in the alternative step f′) by potting the at least one viewing window aperture 24 with a transparent potting compound 26, in order to sealingly close the viewing window aperture 24, and subsequently sanding and polishing the hardened transparent potting compound 26 in step f″). Lastly, the display element 10 is also electrically connected to an electrical energy supply and control device 16 in step g).

The invention is not limited to the exemplary embodiment above, which serves merely for general explanation of the core concept of the invention. Rather, both the method according to the invention and the device according to the invention can also take on different embodiments to those described above within the scope of protection. The method and the device may in this case in particular have features which are a combination of the respective individual features of the claims.

Reference signs in the claims, the description and the drawings serve merely for better understanding of the invention and are not intended to limit the scope of protection.

### List of Reference Signs

1 Display unit
2 Motor vehicle
3 Transparent viewing window layer
3′ Transparent viewing window layer
4 Compression region
4′ Compression region
4″ Compression region
5 Expansion region
5′ Expansion region
5″ Expansion region
10 Display element
11 E-paper film
12 Active display region
13 Fastening edge
14 Adhesive layer
15 Electrical ground of the motor vehicle
16 Energy supply and control device
17 First electrical supply line
18 Positive pole contact
19 Second electrical supply line
20 Motor vehicle body
20′ Body structure
21 Outer surface
22 Body outer skin
22′ Coat of paint
23 Inner surface
24 Viewing window aperture
24′ Viewing window aperture
24″ Viewing window aperture
24′″ Viewing window aperture
25 Adhesive web
25′ Large-area adhesive layer
26 Potting compound
27 Adhesive layer
28 Internal covering
29 External covering
29′ Cover
30 Transparent film
32 Transparent potting compound
40 Compression element
40′ Compression element
40″ Compression element
50 Expansion element
100 Body panel
A Vehicle outer side
B Vehicle inner side

1.-9. (canceled)

10. A method for integrating an electrically activatable display element in a body outer skin of a motor vehicle body or a motor vehicle body element, the method comprising the steps of:
a) providing a body structure comprising the body outer skin, the body outer skin having an outer surface facing a vehicle outer side and an inner surface facing a vehicle inner side;
b) providing at least one viewing window aperture in the body outer skin;
c) depositing at least one adhesive web on the inner surface of the body outer skin in a region of edges of the at least one viewing window aperture;
d) applying the display element to the adhesive web;
e) applying a potting compound, from the vehicle inner side, to the display element and to that region of the inner surface of the body outer skin that surrounds the display element, in order to seal the display element with respect to a surrounding area on the vehicle inner side; and, either:
f) applying a transparent film, from the body outer side, to the outer surface of the body outer skin at least in a region of the at least one aperture, so as to sealingly surround the edges of the aperture, or
f′) potting the at least one aperture with a transparent potting compound, in order to sealingly close the aperture, and
f″) sanding and polishing the transparent potting compound when hardened;
g) connecting the display element to an electrical energy supply and control device.

11. The method according to claim 10, wherein
the display element is formed by a display film into which a pattern of compression slots, which pass through the display film in a thickness direction and confer flexible properties on the display element, is cut in a pretreatment step prior to applying the display element to the adhesive web in step (d).

12. The method according to claim 10, wherein the display film is an e-paper film.

13. The method according to claim 10, wherein
the body outer skin is subjected to cathodic dip coating prior to the depositing of the adhesive web in step (c).

14. The method according to claim 10, wherein
the outer surface of the body outer skin is provided with a paint finish comprising at least one coat of paint after the depositing of the adhesive web in step (c) and before the application of the display element in step (d).

15. The method according to claim 10, wherein
an external covering which covers the display unit is applied and connected to the inner surface of the body outer skin after the application of the potting compound in step (e).

16. The method according to claim 10, wherein
the adhesive web deposited on the inner surface of the body outer skin in step (c) surrounds the edge of the at least one viewing window aperture.

17. The method according to claim 10, wherein
the adhesive web deposited on the inner surface of the body outer skin forms a closed adhesive layer, to which the display element is connected over a large area in step (d).

18. A motor vehicle, comprising:
a body outer skin of a motor vehicle body or a motor vehicle body element;
an electrically activatable display element integrated into at least one viewing window aperture which is formed in the body outer skin and behind which the display element is provided on an inner side of the body outer skin; and
a transparent viewing window layer provided in or on an outer surface of the body outer skin in front of or in the at least one viewing window aperture,
wherein
the at least one viewing window aperture is covered by a transparent film connected to the body outer skin.

19. A motor vehicle, comprising:
a body outer skin of a motor vehicle body or a motor vehicle body element;
an electrically activatable display element integrated into at least one viewing window aperture which is formed in the body outer skin and behind which the display element is provided on an inner side of the body outer skin; and
a transparent viewing window layer provided in or on an outer surface of the body outer skin in front of or in the at least one viewing window aperture;
a transparent potting compound that fills the at least one viewing window aperture, and is polished on an outer side thereof such that a surface merges seamlessly into a surrounding outer surface of the body outer skin.
